(19) United States
(12) Patent Application Publication
(10) Pub. No.: US 2013/0066639 A1
(43) Pub. Date: Mar. 14, 2013

(54) SIGNAL PROCESSING METHOD, ENCODING APPARATUS THEREOF, AND DECODING APPARATUS THEREOF

(71) Applicants: Nam-suk LEE, Suwon-si (KR); Han-gil MOON, Seoul (KR)

(72) Inventors: Nam-suk LEE, Suwon-si (KR); Han-gil MOON, Seoul (KR)

(73) Assignee: SAMSUNG ELECTRONICS CO., LTD., Suwon-si (KR)

(21) Appl. No.: 13/614,213

(22) Filed: Sep. 13, 2012

(30) Foreign Application Priority Data
Sep. 14, 2011 (KR) 10-2011-0092560

(51) Int. Cl. G10L 19/00

(52) U.S. Cl. 704/500; 704/E19.005

(57) ABSTRACT

A signal processing method performed by an encoding apparatus that down-mixes first through n channel signals to a mono-signal, an encoding apparatus, a decoding apparatus, and a decoding method are provided. The signal processing method includes: generating a spatial parameter between a reference channel signal that is from among the first through n channel signals, and residual channel signals from among the first through n channel signals except for the reference channel signal; and encoding and transmitting the spatial parameter to a decoding apparatus, whereby a down-mixed mono-signal may be exactly restored to original channel input signals.

### CROSS-REFERENCE TO RELATED PATENT APPLICATION

This application claims priority from Korean Patent Application No. 10-2011-0092560, filed on Sep. 14, 2011 in the Korean Intellectual Property Office, the disclosure of which is incorporated herein in its entirety by reference.

### BACKGROUND

1. Field

Apparatuses and methods consistent with exemplary embodiments relate to a signal processing method of down-mixing a plurality of channels, an encoding apparatus thereof, and a decoding apparatus thereof, and more particularly, to a signal processing method of down-mixing n channel signals to one mono-signal, an encoding apparatus thereof, and a decoding apparatus thereof.

2. Description of the Related Art

An encoding apparatus and a decoding apparatus for multi-channel input and output encode and decode an audio signal including a voice, music, or the like by using a predetermined codec, and transceive an encoded signal and a decoded signal. With respect to an audio codec, if there is one input/output channel, the channel is referred to as a mono-channel, if there are two input/output channels, the channels are referred to as stereo channels, and if there are three or more input/output channels, the channels are referred to as multi-channels.

The encoding apparatus that operates according to a multi-channel codec down-mixes n channel signals to m channel signals. Also, when the down-mixing is performed, a spatial parameter is extracted. The encoding apparatus encodes the down-mixed signals and the spatial parameter, and transmits a corresponding transport stream (TS) to the decoding apparatus.

In the down-mixing, in order to reduce the number of output channels, compared to the number of input channels, reverse one to two (R-OTT) conversion or reverse two to three (R-TTT) conversion is performed. Here, the R-OTT conversion indicates conversion in which two input signals are received and then one signal is output, and the R-TTT conversion indicates conversion in which three input signals are received and then two signals are output.

FIG. 1 is a diagram describing an encoding apparatus 100 for down-mixing multi-channel signals.

Referring to FIG. 1, the encoding apparatus 100 includes a plurality of R-OTT converters R-OTT1 through R-OTT7. The R-OTT converters R-OTT1 through R-OTT7 receive a plurality of input signals ch1 though ch8 that are multiple channels, perform down-mixing by using R-OTT conversion, and then finally generate one mono-signal M.

As illustrated in FIG. 1, 2n input signals are input to n R-OTT converters (e.g., the R-OTT converters R-OTT1 through R-OTT4). Each of the n R-OTT converters (e.g., the R-OTT converter R-OTT1) generates a first mono-signal (e.g., ch11) by down-mixing two input signals, and then generates a spatial parameter (e.g., P1) indicating a correlation between the two input signals.

Afterward, n first mono-signals (e.g., ch11, ch12, ch13, and ch14) that are output from the n R-OTT converters (e.g., the R-OTT converters R-OTT1 through R-OTT4), respectively, are input again to n/2 R-OTT converters (e.g., the R-OTT converters R-OTT5 and R-OTT6). Each (e.g., the R-OTT converter R-OTT5) of the n/2 R-OTT converters generates a second mono-signal (e.g., ch21) by down-mixing the first mono-signals (e.g., ch11 and ch12), and then generates a spatial parameter (e.g., P11) indicating a correlation between the first mono-signals (e.g., ch11 and ch12) input to.

Finally, the R-OTT converter R-OTT7 generates a final down-mixed signal M by down-mixing second mono-signals (e.g., ch21 and ch22), and then generates a corresponding spatial parameter (i.e., P21).

Whenever an R-OTT converted signal is restored one time, a decoding error occurs. As described above, in order to down-mix the eight input signals to the final down-mixed signal M, the R-OTT conversion is performed three times. Thus, in a case where a signal that has undergone the R-OTT conversion three times is restored, a decoding error is accumulated three times. Thus, when the original input signals ch1 though ch8 are restored by using the final down-mixed signal M and the spatial parameters P1, P2, P3, P4, P11, P12, and P21, if the decoding error is accumulated as described above, the decoding apparatus cannot restore the input signals ch1 though ch8 into their original forms. In more detail, a signal magnitude difference and a phase difference occur between the restored signals and the original input signals ch1 though ch8, in proportion to the accumulated decoding error.

As described above, when multi-channel signals are down-mixed several times by using the R-OTT conversion or the R-TTT conversion, a quality of a restored signal deteriorates due to a decoding error.

Thus, a method and apparatus for preventing signal quality deterioration that occurs in decoding is demanded.

### SUMMARY

Exemplary embodiments provide a signal processing method capable of preventing signal quality deterioration that occurs in decoding, an encoding apparatus thereof, and a decoding apparatus thereof.

In more detail, exemplary embodiments provide a signal processing method capable of generating or processing a spatial parameter so as to allow a mono-signal to be exactly restored into original n channel input signals when the n channel input signals are down-mixed to the mono-signal, an encoding apparatus thereof, and a decoding apparatus thereof.

According to an aspect of an exemplary embodiment, there is provided a signal processing method performed by an encoding apparatus that down-mixes first through n channel signals to a mono-signal, the signal processing method including: generating a spatial parameter between a reference channel signal that is from among the first through n channel signals, and residual channel signals from among the first through n channel signals except for the reference channel signal; and encoding and transmitting the spatial parameter to a decoding apparatus.

The operation of generating the spatial parameter may include operations of: generating a summation signal by summing the residual channel signals; and generating the spatial parameter by using a correlation between the summation signal and the reference channel signal.

The operation of generating the spatial parameter may include an operation of generating n spatial parameters by using each of the first through n channel signals as the reference channel signal.

The signal processing method may further include an operation of receiving the encoded n spatial parameters and the encoded mono-signal, wherein the receiving is performed by the decoding apparatus.

The signal processing method may further include an operation of restoring the first through n channel signals by using the n spatial parameters and the mono-signal.

The spatial parameter may include an angle parameter indicating a predetermined angle value that denotes a correlation between a signal magnitude of the reference channel signal and signal magnitudes of the residual channel signals.

The operation of generating the spatial parameter may include an operation of generating first through n angle parameters by using each of the first through n channel signals as the reference channel signal, wherein the first through n angle parameters indicate a correlation between a signal magnitude of each of the first through n channel signals that are reference channel signals, and signal magnitudes of the residual channel signals.

Total summation of the first through n angle parameters may be converged to a predetermined value, and the operation of generating the spatial parameter may include an operation of generating the spatial parameter including a k angle residual parameter used to calculate a k angle parameter and angle parameters from among the first through n angle parameters except for the k angle parameter.

The operation of generating the spatial parameter may include operations of: predicting a value of the k angle parameter from among the first through n angle parameters; comparing the predicted value of the k angle parameter with an original value of the k angle parameter; and generating a difference value between the predicted value of the k angle parameter and the original value of the k angle parameter as the k angle residual parameter.

The signal processing method may further include operations of: receiving the spatial parameter including the k angle residual parameter and the angle parameters from among the first through n angle parameters except for the k angle parameter, wherein the receiving is performed by the decoding apparatus; and restoring the k angle parameter by using the received spatial parameter and the predetermined value.

The operation of restoring the k angle parameter may include an operation of subtracting the value of the angle parameters from among the first through n angle parameters except for the k angle parameter from the predetermined value, obtaining a value by compensating for the value of the k angle residual parameter to a value resulting from the subtracting, and then generating the obtained value as the k angle parameter.

According to an aspect of another exemplary embodiment, there is provided a signal processing method performed by an encoding apparatus that down-mixes first through n channel signals to a mono-signal, the signal processing method including: generating a spatial parameter by using a correlation between a reference channel signal that is from among the first through n channel signals, and the mono-signal; and encoding and transmitting the spatial parameter to a decoding apparatus.

According to an aspect of another exemplary embodiment, there is provided an encoding apparatus down-mixing first through n channel signals to a mono-signal, the apparatus including: a down-mixing unit for generating a spatial parameter between a reference channel signal that is from among the first through n channel signals, and residual channel signals from among the first through n channel signals except for the reference channel signal; and an encoder for encoding and transmitting the spatial parameter to a decoding apparatus.

According to an aspect of another exemplary embodiment, there is provided a decoding apparatus including: an inverse-multiplexing unit for receiving a transport stream (TS), and separating a spatial parameter that is encoded; a spatial parameter decoding unit for decoding the spatial parameter; and an up-mixing unit for decoding a mono-signal generated by down-mixing and encoding first through n channel signals, and restoring the first through n channel signals by using the decoded mono-signal and the decoded spatial parameter, wherein the spatial parameter includes at least one of a first spatial parameter between a reference channel signal that is from among the first through n channel signals, and residual channel signals from among the first through n channel signals except for the reference channel signal, and a second spatial parameter between the reference channel signal and the mono-signal.

According to an aspect of another exemplary embodiment, there is provided a decoding method including: decoding an encoded spatial parameter; decoding a mono-signal generated by down-mixing and encoding first through n channel signals; and restoring the first through n channel signals using the decoded mono-signal and the decoded spatial parameter, wherein the spatial parameter includes at least one of a first spatial parameter between a reference channel signal and residual channel signals and a second spatial parameter between the reference channel signal and the mono-signal, the reference channel signal and the residual channel signals being from among the first through n channel signals.

### BRIEF DESCRIPTION OF THE DRAWINGS

The above and other features and advantages will become more apparent by describing in detail exemplary embodiments with reference to the attached drawings in which:

FIG. 1 is a diagram describing an encoding apparatus for down-mixing multi-channel signals;

FIG. 2 is a block diagram illustrating an encoding apparatus according to an exemplary embodiment;

FIG. 3 is a flowchart of a signal processing method, according to an exemplary embodiment;

FIG. 4 is a flowchart of a signal processing method, according to another exemplary embodiment;

FIG. 5 is a block diagram illustrating a decoding apparatus according to an exemplary embodiment;

FIGS. 6A-6C illustrate diagrams describing an operation of FIG. 3;

FIG. 7 illustrates another diagram describing the operation of FIG. 3;

FIGS. 8A-8C illustrate an original channel signal and restored channel signals;

FIGS. 9A-9D illustrate a diagram describing the operation of FIG. 3;

FIG. 10 is a graph illustrating total summation of angle parameters according to an exemplary embodiment;

FIG. 11 is a diagram describing calculation of angle parameters according to an exemplary embodiment; and

FIG. 12 illustrates data regions used to transmit first through n angle parameters according to an exemplary embodiment.

### DETAILED DESCRIPTION OF EXEMPLARY EMBODIMENTS

Hereinafter, a signal processing method, an encoding apparatus, and a decoding apparatus according to one or more exemplary embodiments will be described in detail by explaining exemplary embodiments with reference to the attached drawings.

Expressions such as “at least one of,” when preceding a list of elements, modify the entire list of elements and do not modify the individual elements of the list.

A spatial parameter contains information used to restore a down-mixed signal into original input channel signals. In more detail, the spatial parameter is generated by using a correlation between the input channel signals, and may broadly include a parameter indicating a signal level difference between the input channel signals, and a parameter indicating the correlation between the input channel signals.

Hereinafter, the parameter indicating the signal level difference between the input channel signals is referred to as ‘first parameter’. In more detail, the first parameter may include a channel level difference (CLD) parameter. The parameter which indicates the correlation, e.g., a similarity, between the input channel signals is referred to as ‘second parameter’ hereinafter. In more detail, the second parameter may include at least one of an inter channel correlation (ICC) parameter, an overall phase difference (OPD) parameter, and an inter phase difference (IPD) parameter.

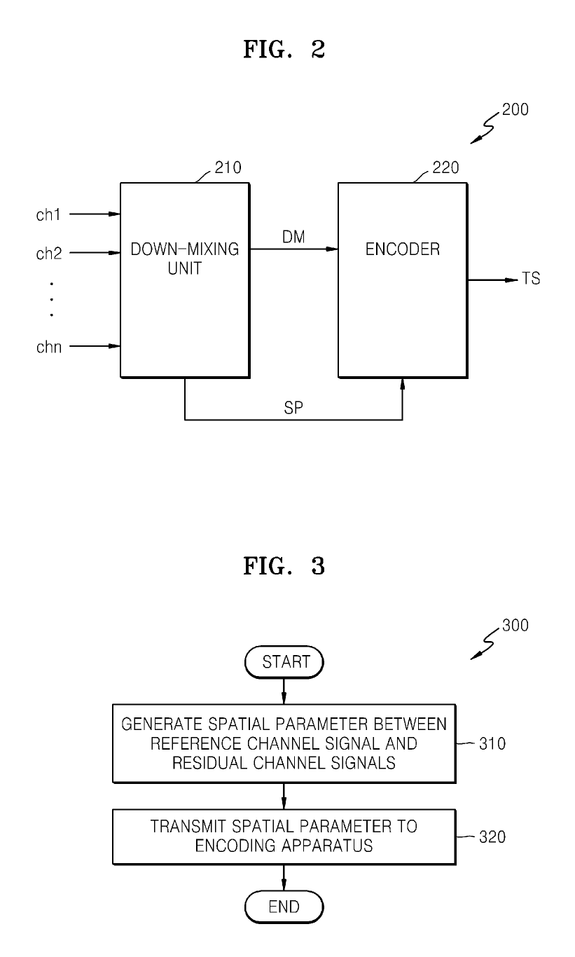

FIG. 2 is a block diagram illustrating an encoding apparatus 200 according to an exemplary embodiment.

Referring to FIG. 2, the encoding apparatus 200 includes a down-mixing unit 210 and an encoder 220.

The encoding apparatus 200 down-mixes and encodes first through n channel signals ch1 through chn to a mono-signal DM.

The down-mixing unit 210 may receive the first through n channel signals ch1 through chn that are multi-channel signals and may generate a spatial parameter between a reference channel signal that is from among the first through n channel signals ch1 through chn, and residual channel signals from among the first through n channel signals ch1 through chn except for the reference channel signal. Hereinafter, a signal obtained by summing the residual channel signals from among the first through n channel signals ch1 through chn except for the reference channel signal is referred to as a ‘first summation signal’. Also, the spatial parameter between the reference channel signal and the first summation signal is referred to as a ‘first spatial parameter’ hereinafter. That is, the down-mixing unit 210 may generate the first spatial parameter between the reference channel signal and the first summation signal.

Also, the down-mixing unit 210 may generate a spatial parameter between the first through n channel signals ch1 through chn and the reference channel signal that is from among the first through n channel signals ch1 through chn. Hereinafter, a signal obtained by summing the first through n channel signals ch1 through chn is referred to as a ‘second summation signal’. Also, the spatial parameter between the reference channel signal and the second summation signal is referred to as a ‘second spatial parameter’ hereinafter. That is, the down-mixing unit 210 may generate the second spatial parameter between the reference channel signal and the second summation signal.

Each of the spatial parameters generated by the down-mixing unit 210 may include at least one of the first spatial parameter indicating relative signal magnitudes of input channel signals, and the second spatial parameter indicating a correlation between the input channel signals.

Hereinafter, spatial parameter generating operations by the down-mixing unit 210 will be described in detail with reference to FIGS. 3 through 6C.

The down-mixing unit 210 generates the mono-signal DM by down-mixing the first through n channel signals ch1 through chn.

The encoder 220 encodes a spatial parameter SP generated by the down-mixing unit 210, and transmits the spatial parameter SP to a decoding apparatus (not shown). Also, the encoder 220 encodes the mono-signal DM generated by the down-mixing unit 210.

In more detail, the encoder 220 encodes the spatial parameter SP and the mono-signal DM generated by the down-mixing unit 210, and converts the encoded spatial parameter SP and mono-signal DM into a transport stream TS. The transport stream TS is transmitted to the decoding apparatus.

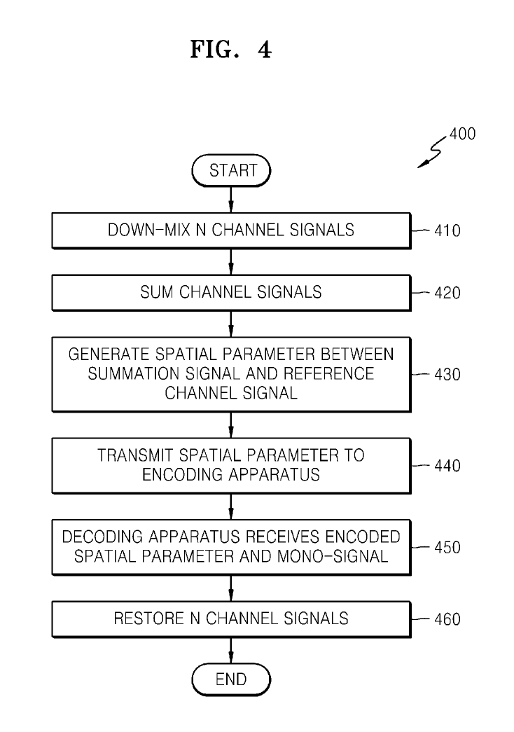

Detailed operations of the encoding apparatus 200 are the same as or similar to detailed operations involved in signal processing methods 300 and 400 according to exemplary embodiments, which will be described with reference to FIGS. 3 and 4.

FIG. 3 is a flowchart of a signal processing method 300, according to an exemplary embodiment. The signal processing method 300 may be implemented in the encoding apparatus 200 described with reference to FIG. 2. Also, operations involved in the signal processing method 300 are the same as or similar to operations by the down-mixing unit 210, respectively, so that detailed descriptions, which are the same as the aforementioned description with reference to FIG. 2, will be omitted.

Referring to FIG. 3, the signal processing method 300 may include receiving the first through n channel signals ch1 through chn that are multi-channel signals and may generate the first spatial parameter that is a spatial parameter between a reference channel signal that is from among the first through n channel signals ch1 through chn, and residual channel signals from among the first through n channel signals ch1 through chn except for the reference channel signal (operation 310). In operation 310, the aforementioned second spatial parameter may be generated, instead of the first spatial parameter. Also, operation 310 may further include an operation of generating the mono-signal DM by down-mixing the first through n channel signals ch1 through chn.

Operation 310 may be performed by the down-mixing unit 210.

A spatial parameter SP generated in operation 310 is encoded and transmitted to a decoding apparatus (not shown) (operation 320). In more detail, the spatial parameter SP transmitted in operation 320 may include at least one of the first spatial parameter and the second spatial parameter. In more detail, in operation 320, the spatial parameter SP and the mono-signal DM may be encoded and converted into a transport stream TS, and the transport stream TS may be transmitted to the decoding apparatus.

Operation 320 may be performed by the encoder 220 of FIG. 2.

FIG. 4 is a flowchart of the signal processing method 400, according to another exemplary embodiment. In the signal processing method 400, operations 430 and 440 correspond to operations 310 and 320 of the signal processing method 300, respectively, so that detailed descriptions, which are the same as or similar to the aforementioned descriptions with reference to FIG. 3, will be omitted here. Compared to the signal processing method 300 described with reference to FIG. 3, the signal processing method 400 may further include at least one of operations 410, 420, 450, and 460.

Referring to FIG. 4, the signal processing method 400 includes down-mixing first through n channel signals ch1 through chn that are multi-channel signals (operation 410). In more detail, the first through n channel signals ch1 through chn may be down-mixed to one mono-signal DM. Operation 410 may be performed by the down-mixing unit 210.

(n−1) channel signals from among the first through n channel signals ch1 through chn may be summed or the first through n channel signals ch1 through chn may be summed (operation 420). In more detail, the residual channel signals from among the first through n channel signals ch1 through chn except for a reference channel signal may be summed, and a summed signal indicates the aforementioned first summation signal. Alternatively, all of the first through n channel signals ch1 through chn may be summed, and a summed signal indicates the aforementioned second summation signal.

Then, by using a correlation between the first summation signal generated in operation 420, and the reference channel signal, the aforementioned first spatial parameter may be generated (operation 430). Alternatively, the first spatial parameter may not be generated but the aforementioned second spatial parameter may be generated by using a correlation between the second summation signal generated in operation 420, and the reference channel signal (operation 430).

The reference channel signal may be each of the first through n channel signals ch1 through chn. Thus, the number of the reference channel signals may be n, and the number of the spatial parameters corresponding to the reference channel signals may be n.

Thus, operation 430 may further include an operation of generating n spatial parameters by using the first through n channel signals ch1 through chn as the reference channel signals, respectively.

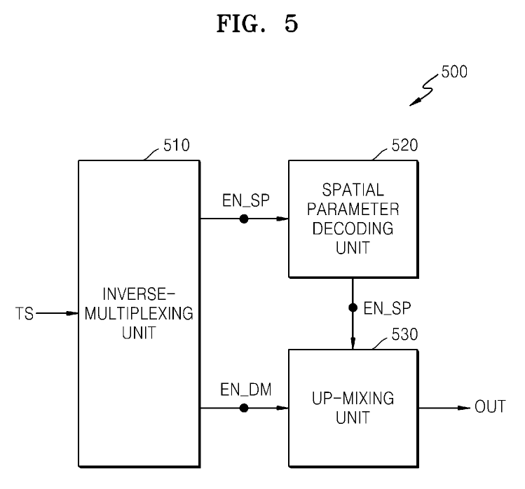

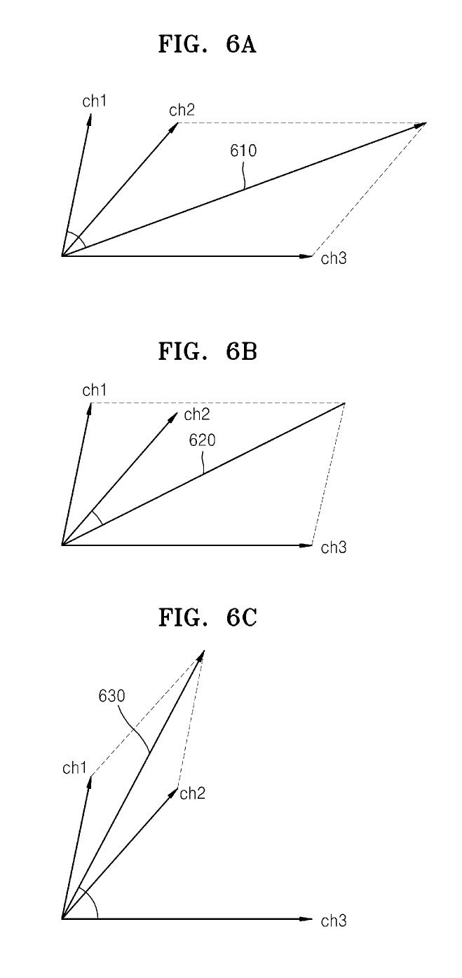

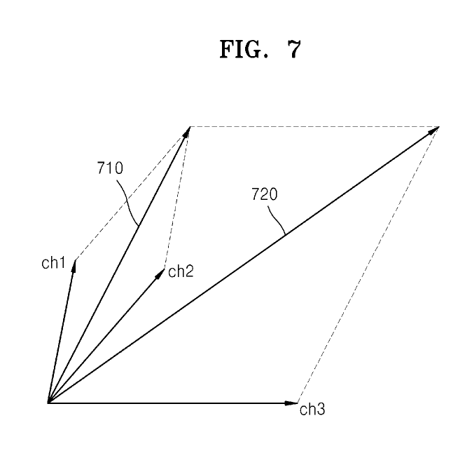

Operations 420 and 430 may be performed by the down-mixing unit 210, and will now be described in detail with reference to FIGS. 6 and 7.

A spatial parameter SP generated in operation 430 is encoded and transmitted to a decoding apparatus (not shown) (operation 440). Also, the mono-signal DM generated in operation 410 is encoded and transmitted to the decoding apparatus. In more detail, the encoded spatial parameter SP and the encoded mono-signal DM may be included in a transport stream TS and then may be transmitted to the decoding apparatus. The spatial parameter SP included in the transport stream TS indicates a spatial parameter set including the aforementioned first through n spatial parameters.

Operation 440 may be performed by the encoder 220 of FIG. 2.

Operations 450 and 460 will now be described in detail with reference to FIG. 5.

FIG. 5 is a block diagram illustrating a decoding apparatus 500 according to an exemplary embodiment.

The decoding apparatus 500 includes an inverse-multiplexing unit 510, a spatial parameter decoding unit 520, and an up-mixing unit 530.

The inverse-multiplexing unit 510 receives a transport stream TS including an encoded spatial parameter EN_SP and an encoded mono-signal EN_DM from the encoding apparatus 200 (operation 450).

In more detail, the inverse-multiplexing unit 510 separates the encoded spatial parameter EN_SP from the transport stream TS and then outputs the encoded spatial parameter EN_SP to the spatial parameter decoding unit 520. Also, the inverse-multiplexing unit 510 separates the encoded mono-signal EN_DM from the transport stream TS and then outputs the encoded mono-signal EN_DM to the up-mixing unit 530.

The spatial parameter decoding unit 520 decodes the encoded spatial parameter EN_SP output from the inverse-multiplexing unit 510. A decoded spatial parameter DE_SP is transmitted to the up-mixing unit 530. Also, the decoded spatial parameter DE_SP may include at least one of the n first spatial parameters and the n second spatial parameters.

The up-mixing unit 530 decodes the mono-signal EN_DM generated by down-mixing and encoding the first through n channel signals ch1 through chn, and restores the first through n channel signals ch1 through chn by using a decoded mono-signal and the decoded spatial parameter DE_SP (operation 460). That is, the up-mixing unit 530 generates first through n channel signals corresponding to the first through n channel signals ch1 through chn described above by up-mixing the decoded mono-signal by using decoded n spatial parameters.

FIGS. 6A-6C illustrate diagrams describing operation 310 of FIG. 3. Also, FIGS. 6A-6C illustrate diagrams describing operations 420 and 430 of FIG. 4, which correspond to operation 310 of FIG. 3. Hereinafter, an operation of generating a first summation signal and a first spatial parameter will be described in detail with reference to FIGS. 6A-6C. FIGS. 6A-6C correspond to examples in which multi-channel signals include first through third channel signals ch1, ch2, and ch3. In the examples of FIG. 6A-6C, signal summation corresponds to vector summation of signals. The signal summation means the down-mixing, and various down-mixing methods other than the vector summation may be used in one or more other exemplary embodiments.

FIGS. 6A, 6B, and 6C respectively indicate cases in which reference channel signals are a first channel signal ch1, a second channel signal ch2, and a third channel signal ch3.

Referring to FIG. 6A, when the reference channel signal is the first channel signal ch1, the down-mixing unit 210 generates a summation signal 610 by summing the second and third channel signals ch2 and ch3 except for the reference channel signal (ch2+ch3). Then, the down-mixing unit 210 generates a spatial parameter by using a correlation between the summation signal 610 and the first channel signal ch1 that is the reference channel signal (ch1, and ch2+ch3). As described above, a spatial parameter contains information indicating a correlation between a reference channel signal and a summation signal, and information indicating relative signal magnitudes of the reference channel signal and the summation signal.

Referring to FIG. 6B, when the reference channel signal is the second channel signal ch2, the down-mixing unit 210 generates a summation signal 620 by summing the first and third channel signals ch1 and ch3 except for the reference channel signal (ch1+ch3). Then, the down-mixing unit 210 generates a spatial parameter by using a correlation between the summation signal 620 and the second channel signal ch2 that is the reference channel signal (ch2, and ch1+ch3).

Referring to FIG. 6C, when the reference channel signal is the third channel signal ch3, the down-mixing unit 210 generates a summation signal 630 by summing the first and second channel signals ch1 and ch2 except for the reference channel signal (ch1+ch2). Then, the down-mixing unit 210 generates a spatial parameter by using a correlation between the summation signal 630 and the third channel signal ch3 that is the reference channel signal (ch3, and ch1+ch2).

As described above, in a case where the multi-channel signals include three channel signals, the number of the reference channel signals is 3, and three spatial parameters may be generated. The generated spatial parameters are encoded by the encoder 220 and are transmitted to the decoding apparatus 500.

The mono-signal DM obtained by down-mixing the first, second, and third channel signals ch1, ch2, and ch3 is equal to the summation signal of the first, second, and third channel signals ch1, ch2, and ch3, and may be expressed in a manner of DM=ch1+ch2+ch3. Thus, a relation of ch1=DM−(ch2+ch3) is formed.

The decoding apparatus 500 receives and decodes the first spatial parameter that is the spatial parameter described with reference to FIGS. 6A-6C. Then, the decoding apparatus 500 restores original channel signals by using a decoded mono-signal and the decoded spatial parameter. As described above, the relation of ch1=DM−(ch2+ch3) is formed, and the spatial parameter generated in the case of FIG. 6A may include a parameter indicating relative magnitudes of signals (i.e., ch1, and ch2+ch3), and a parameter indicating a similarity of the signals (i.e., ch1, and ch2+ch3), so that the signals ch1 and ch2+ch3 may be restored by using the spatial parameter and the mono-signal DM generated in the case of FIG. 6A. Similarly, the signals ch2 and ch1+ch3, and the signals ch3 and ch1+ch2 may be restored by using the spatial parameters generated in the cases of FIGS. 6B and 6C, respectively. That is, the up-mixing unit 530 may restore all of the first, second, and third channel signals ch1, ch2, and ch3.

FIG. 7 illustrates another diagram describing operation 310 of FIG. 3. Also, FIG. 7 illustrates a diagram describing operations 420 and 430 of FIG. 4, which correspond to operation 310 of FIG. 3. Hereinafter, an operation of generating a second summation signal and a second spatial parameter will be described in detail with reference to FIG. 7. FIG. 7 corresponds to an example in which multi-channel signals include first through third channel signals ch1, ch2, and ch3. In the example of FIG. 7, signal summation corresponds to vector summation of signals, though it is understood that another exemplary embodiment is not limited thereto.

Referring to FIG. 7, the second summation signal is obtained by summing all of the first through third channel signals ch1, ch2, and ch3 that are multi-channel signals, so that a signal 720 (ch1+ch2+ch3) obtained by summing a signal 710 that is a summation of the first and second channels signals ch1 and ch2, and the third channel signal ch3, is the second summation signal.

A spatial parameter between the first channel signal ch1 and the second summation signal 720 is generated by using the first channel signal ch1 as a reference channel signal. In more detail, the spatial parameter including at least one of the first parameter and the second parameter may be generated by using a correlation between the first channel signal ch1 and the second summation signal 720 (ch1, and ch1+ch2+ch3).

Then, a spatial parameter is generated by using the second channel signal ch2 as a reference channel signal and by using a correlation between the second channel signal ch2 and the second summation signal 720 (ch2, and ch1+ch2+ch3). Also, a spatial parameter is generated by using the third channel signal ch3 as a reference channel signal and by using a correlation between the third channel signal ch3 and the second summation signal 720 (ch3, and ch1+ch2+ch3).

The decoding apparatus 500 receives and decodes the first spatial parameter that is the spatial parameter described with reference to FIG. 7. Then, the decoding apparatus 500 restores original channel signals by using a decoded mono-signal and the decoded spatial parameter. Here, the decoded mono-signal corresponds to the second summation signal 720 (ch1+ch2+ch3) of the multi-channel signals.

Thus, the first channel signal ch1 may be restored by using the decoded mono-signal and the spatial parameter generated by using the correlation between the first channel signal ch1 and the second summation signal 720 (ch1, and ch1+ch2+ch3). Similarly, the second channel signal ch2 may be restored by using the decoded mono-signal and the spatial parameter generated by using the correlation between the second channel signal ch2 and the second summation signal 720 (ch2, and ch1+ch2+ch3). Also, the third channel signal ch3 may be restored by using the decoded mono-signal and the spatial parameter generated by using the correlation between the third channel signal ch3 and the second summation signal 720 (ch3, and ch1+ch2+ch3).

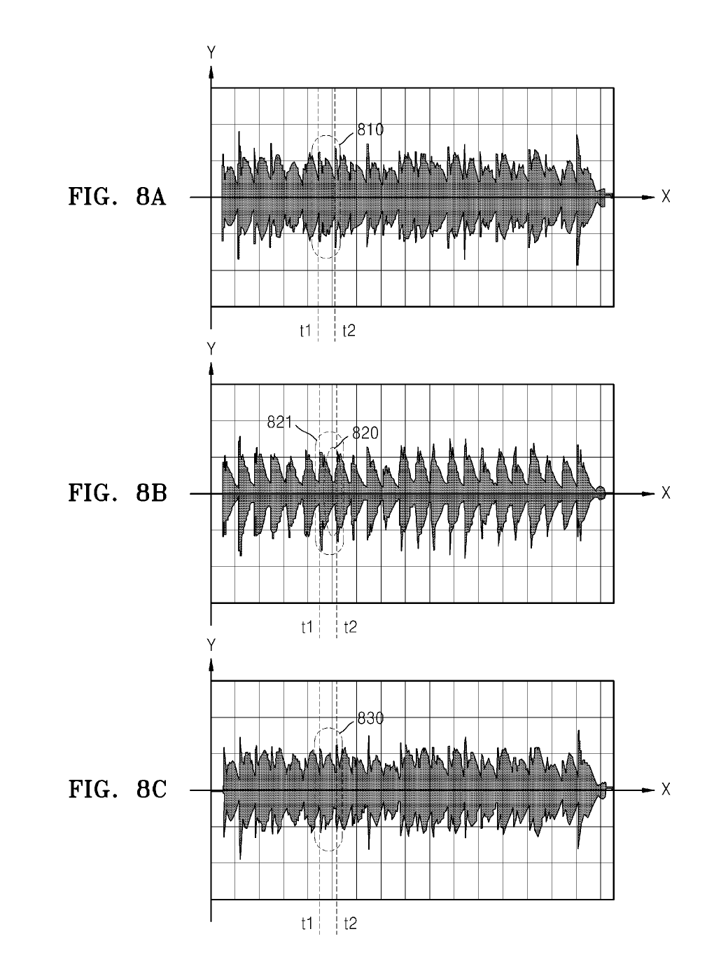

FIGS. 8A-8C illustrate an original channel signal 810 and restored channel signals 821 and 830.

FIG. 8A illustrates an example of the original channel signal 810 input to the encoding apparatus 200. In FIG. 8A, an X-axis indicates a time, and a Y-axis indicates signal magnitudes of channel signals.

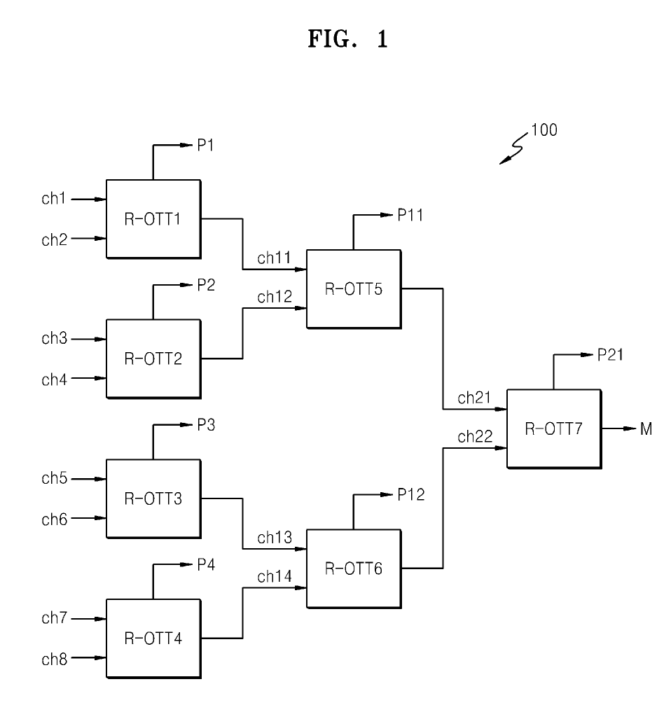

FIG. 8B illustrates a channel signal (hereinafter, referred to as a related art restored signal 821′) that is restored by using a mono-signal M and spatial parameters P1, P2, P3, P4, P11, P12, and P21 generated by an encoding apparatus 100 according to the related art described above with reference to FIG. 1.

FIG. 8C illustrates a channel signal (hereinafter, referred to as a ‘present-exemplary embodiment restored signal 830’) that is restored by using a mono-signal and spatial parameters generated by the encoding apparatus 200 according to an exemplary embodiment or by one of the signal processing methods 300 and 400 according to exemplary embodiments.

Referring to FIG. 8A, the original channel signal 810 has a waveform as shown in (a) of FIG. 8 in a period from t1 to t2, which is a temporal period. However, referring to FIG. 8B, compared to the original channel signal 810, it is apparent that the related art restored signal 821 has a signal loss in a predetermined period 820 within the period from t1 to t2.

That is, when the related art restored signal 821 is reproduced, due to the signal loss of the related art restored signal 821, which is incurred due to a decoding error or the like, sound quality deteriorates.

Compared to the related restored signal 821, referring to FIG. 8C, the present-exemplary embodiment restored signal 830 has almost the same waveform as that of the original channel signal 810.

Thus, the signal processing method, the encoding apparatus thereof, and the decoding apparatus thereof according to one or more exemplary embodiments may further exactly restore a signal to the original channel signal 810, and may prevent signal loss and sound deterioration due to a decoding error or the like.

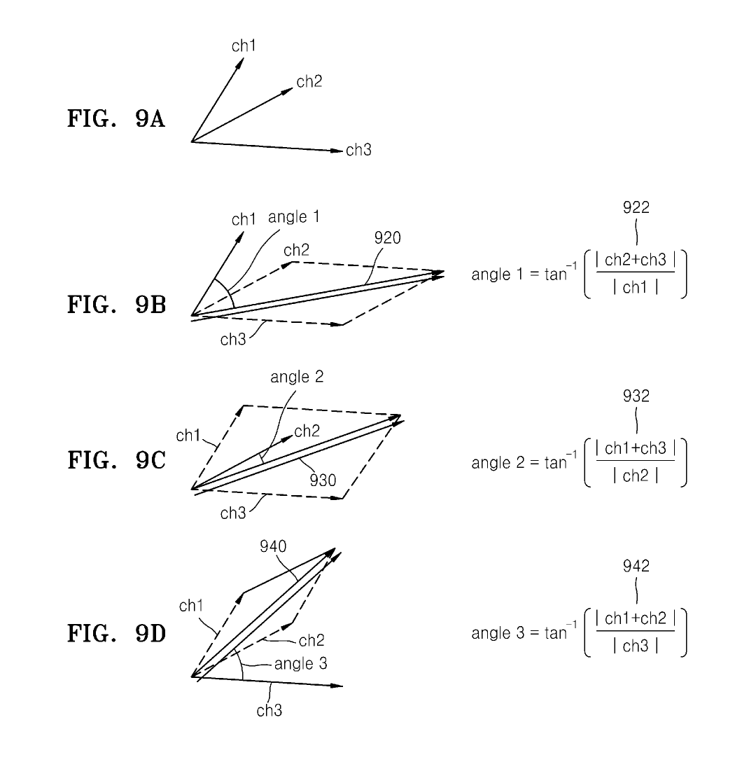

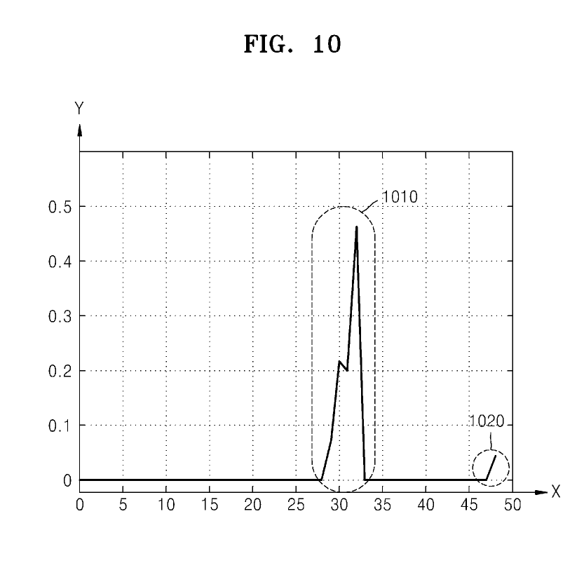

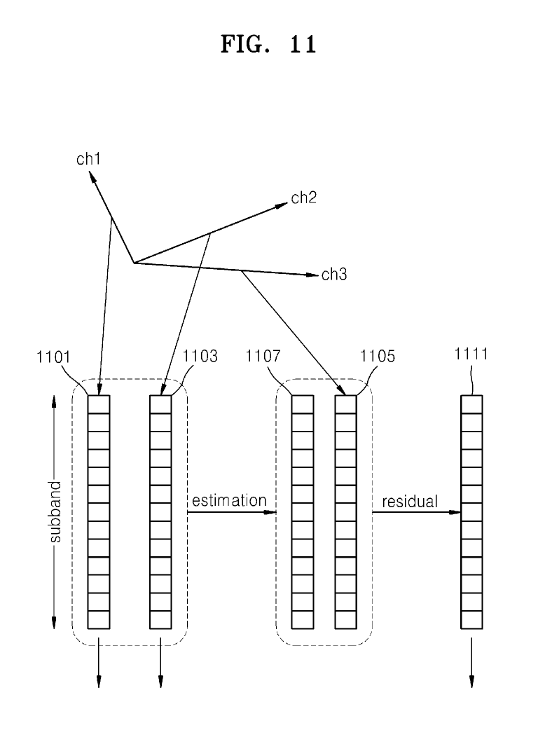

FIGS. 9A-9D illustrate diagrams describing operation 310 of FIG. 3. Also, FIGS. 9A-9D illustrate diagrams describing operations 420 and 430 of FIG. 4, which correspond to operation 310 of FIG. 3.

A spatial parameter generated by the down-mixing unit 210 may include an angle parameter as a first parameter.

In more detail, at least one of operations 310 and 430 for generating a spatial parameter may include an operation of generating the angle parameter.

The angle parameter indicates a predetermined angle value denoting a correlation between a signal magnitude of a reference channel signal that is from among first through n channel signals ch1 through chn, and signal magnitudes of the residual channel signals from among the first through n channel signals ch1 through chn except for the reference channel signal. Also, the angle parameter may be referred to as a global vector angle (GVA).

The angle parameters indicate angle values denoting relative magnitudes of the reference channel signal and a first summation signal.

The down-mixing unit 210 may generate first through n angle parameters by using the first through n channel signals ch1 through chn as reference channel signals, respectively. Hereinafter, an angle parameter that is generated by using a k channel signal as a reference channel signal is referred to as a k angle parameter.

Referring to FIG. 9A, multi-channel signals input to the encoding apparatus 200 include first, second, and third channel signals ch1, ch2, and ch3.

FIGS. 9B, 9C, and 9D respectively indicate cases in which reference channel signals are the first channel signal ch1, the second channel signal ch2, and the third channel signal ch3.

Referring to FIG. 9B, when the reference channel signal is the first channel signal ch1, the down-mixing unit 210 sums (ch2+ch3) the second and third channel signals ch2 and ch3 that are the residual channel signals except for the reference channel signal, and obtains a first angle parameter (angle 1) 922 that is an angle parameter between a summation signal 920 and the first channel signal ch1. In an example of FIG. 9B, signal summation corresponds to vector summation of signals.

In more detail, the first angle parameter (angle 1) 922 may be obtained by performing an inverse-tangent operation on a value obtained by dividing an absolute value of the summation signal 920 (i.e., ch2+ch3) by an absolute value of the first channel signal ch1.

Referring to FIG. 9C, a second angle parameter (angle 2) 932 using the second channel signal ch2 as the reference channel signal may be obtained by performing an inverse-tangent operation on a value obtained by dividing an absolute value of a summation signal 930 (i.e., ch1+ch3) by an absolute value of the second channel signal ch2.

Referring to FIG. 9D, a third angle parameter (angle 3) 942 using the third channel signal ch3 as the reference channel signal may be obtained by performing an inverse-tangent operation on a value obtained by dividing an absolute value of a summation signal 940 (i.e., ch1+ch2) by an absolute value of the third channel signal ch3.

FIG. 10 is a graph illustrating total summation of angle parameters.

In more detail, total summation of n angle parameters calculated by using first through n channel signals as reference channel signals, respectively, is converged to a predetermined value. The converged predetermined value may vary according to a value of n, and thus may be experimentally optimized.

In the graph of FIG. 10, an X-axis indicates an angle value, and a Y-axis indicates variance likelihood. Also, regarding the angle value in the present exemplary embodiment, one unit corresponds to 6 degrees, e.g., a value of 30 on the X-axis indicates 180 degrees.

Referring to FIG. 10, when the number of the n angle parameters is 3, total summation of angle parameters is converged near an X-axis value of 30 units, i.e., near a point 1010 of 180 degrees. The graph of FIG. 10 was experimentally calculated.

However, there is an exceptional case in which the total summation of angle parameters is converged near an X-axis value of 45 units, i.e., near a point 1020 of 270 degrees. The case in which the predetermined value is converged near the point 1020 of 270 degrees is when each of the angle parameters has a value of 90 degrees since the three channel signals are all mute. Regarding this exceptional case, if a value of one of the three angle parameters is changed to 0, the total summation of the angle parameters is converged to 180 degrees. In a case where the three channel signals are all mute, a down-mixed mono-signal also has a value of 0, and a signal obtained by up-mixing and decoding the down-mixed mono-signal has a value of 0. Thus, although the value of one of the three angle parameters is changed to 0, up-mixing and decoding results are not changed, so that the value of one of the three angle parameters being to 0 is not concerning.

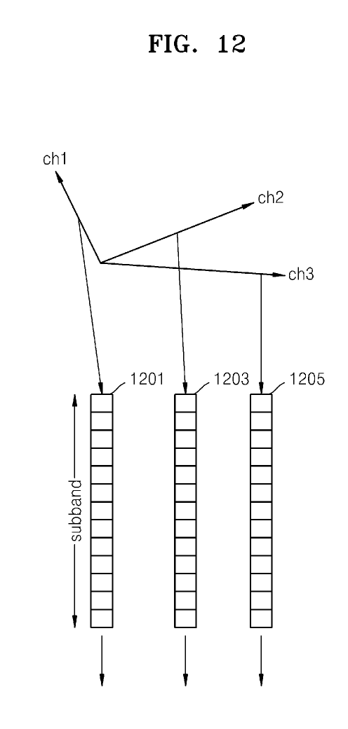

Also, at least one of operations 310 and 430 for generating a spatial parameter may include an operation of generating the spatial parameter including a k angle residue parameter used to calculate a k angle parameter and angle parameters from among the first through n angle parameters except for the k angle parameter. The k angle residue parameter will now be described in detail with reference to FIG. 11.

FIG. 11 is a diagram describing calculation of angle parameters according to an exemplary embodiment. FIG. 11 corresponds to an example in which multi-channel signals include first, second, and third channel signals ch1, ch2, and ch3.

Referring to FIG. 11, when the first channel signal ch1 is a reference channel signal, a first angle parameter is calculated and encoded, and then the encoded first angle parameter is included in a predetermined bit region 1101 and transmitted to the decoding apparatus 500. When the second channel signal ch2 is a reference channel signal, a second angle parameter is calculated and encoded, and then the encoded second angle parameter is included in a predetermined bit region 1103 and transmitted to the decoding apparatus 500.

When a third angle parameter is the k angle parameter, the k angle residue parameter may be obtained, which will now be described.

As described above, since the total summation of the n angle parameters is converted to the predetermined value, a value of the k angle parameter may be obtained by subtracting a value of the angle parameters from among the first through n angle parameters except for the k angle parameter from the predetermined value. In more detail, when the number of the n angle parameters is 3, if all of the first, second, and third channel signals ch1, ch2, and ch3 are not mute, total summation of the three angle parameters is converged to 180 degrees. Thus, a relation of ‘a value of the third angle parameter=180 degree−(a value of the first angle parameter+a value of the second angle parameter)’ is provided. By using the relation, the third angle parameter may be predicted.

In more detail, the down-mixing unit 210 predicts the value of the k angle parameter from among the first through n angle parameters. The prediction may be performed by using the aforementioned relation and the predetermined value. A predetermined bit region 1107 indicates a data region including a predicted value of the k angle parameter.

The down-mixing unit 210 compares the predicted value of the k angle parameter and the original value of the k angle parameter. A predetermined bit region 1105 indicates a data region including the value of the third angle parameter calculated in a manner shown in FIG. 9D.

The down-mixing unit 210 generates a difference value between the predicted value of k angle parameter 1107 and the value of k angle parameter 1105, as the k angle residue parameter. A predetermined bit region 1111 indicates a data region including a value of the k angle residue parameter.

The encoder 220 encodes the spatial parameter including the angle parameters (i.e., parameters included in the bit regions 1101 and 1103) from among the first through n angle parameters except for the k angle parameter, and the k angle residue parameter (i.e., a parameter included in the bit region 1111), and transmits the spatial parameter to the decoding apparatus 500.

Accordingly, the decoding apparatus 500 receives the spatial parameter including the angle parameters from among the first through n angle parameters except for the k angle parameter, and the k angle residue parameter.

The spatial parameter decoding unit 520 of the decoding apparatus 500 restores the k angle parameter by using the received spatial parameter and the predetermined value.

In more detail, the spatial parameter decoding unit 520 may subtract the value of the angle parameters from among the first through n angle parameters except for the k angle parameter from the predetermined value, may obtain a value by compensating for the value of the k angle residue parameter to a value of the subtraction result, and may generate the obtained value as the k angle parameter.

FIG. 12 illustrates data regions used to transmit first through n angle parameters according to an exemplary embodiment. In FIG. 12, predetermined bit regions 1201 and 1203 equally correspond to the predetermined bit regions 1101 and 1103 of FIG. 11, respectively, and thus, detailed descriptions, which are the same as or similar to the aforementioned contents, will be omitted here.

Referring to FIG. 12, a predetermined bit region 1105 indicates a data region including a value of a third angle parameter.

A value of a k angle residue parameter contains data smaller than a value of a k angle parameter. Thus, when a spatial parameter including angle parameters from among the first through n angle parameters except for the k angle parameter, and the k angle residue parameter is transmitted to the decoding apparatus 500, an amount of data exchanged between the encoding apparatus 200 and the decoding apparatus 500 may be decreased.

That is, compared to an example of FIG. 12 in which a transport stream TS including all of predetermined bit regions 1201, 1203, and 1205 is transmitted to the decoding apparatus 500, an example of FIG. 11 in which a transport stream TS including predetermined bit regions 1101, 1103, and 1111 is transmitted to the decoding apparatus 500 may decrease the amount of data exchange.

As described above, the signal processing method, the encoding apparatus thereof, and the decoding apparatus thereof according to one or more exemplary embodiments may prevent signal quality deterioration that may occur when n channel signals are down-mixed to one mono-signal and then up-mixed.

In more detail, the signal processing method, the encoding apparatus thereof, and the decoding apparatus thereof according to one or more exemplary embodiments may generate or process the spatial parameter that allows the mono-signal to be exactly restored to the original channel input signals.

One or more exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Moreover, one or more units of the above-described units can include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the present invention as defined by the following claims.

What is claimed is:

1. A signal processing method performed by an encoding apparatus that down-mixes first through n channel signals to a mono-signal, the signal processing method comprising:
generating a spatial parameter between a reference channel signal and residual channel signals, the reference channel signal and the residual channel signals being from among the first through n channel signals; and
encoding and transmitting the generated spatial parameter.

2. The signal processing method of claim 1, wherein the generating the spatial parameter comprises:
generating a summation signal by summing the residual channel signals; and
generating the spatial parameter using a correlation between the generated summation signal and the reference channel signal.

3. The signal processing method of claim 2, wherein the generating the spatial parameter using the correlation comprises generating n spatial parameters using each of the first through n channel signals as the reference channel signal.

4. The signal processing method of claim 3, further comprising receiving, by a decoding apparatus, the n spatial parameters, which are encoded, and the mono-signal.

5. The signal processing method of claim 4, further comprising restoring, by the decoding apparatus, the first through n channel signals using the n spatial parameters and the mono-signal.

6. The signal processing method of claim 1, wherein the generated spatial parameter comprises an angle parameter indicating a predetermined angle value that denotes a correlation between a signal magnitude of the reference channel signal and signal magnitudes of the residual channel signals.

7. The signal processing method of claim 6, wherein:
the generating the spatial parameter comprises generating first through n angle parameters using each of the first through n channel signals as the reference channel signal; and
wherein the first through n angle parameters indicate a correlation between a signal magnitude of each of the first through n channel signals that are reference channel signals, and signal magnitudes of the residual channel signals.

8. The signal processing method of claim 7, wherein:
a total summation of the first through n angle parameters converges to a predetermined value; and
the generating the spatial parameter using each of the first through n channel signals as the reference channel signal comprises generating the spatial parameter comprising a k angle residual parameter used to calculate a k angle parameter and angle parameters from among the first through n angle parameters except for the k angle parameter.

9. The signal processing method of claim 8, wherein the generating the spatial parameter comprising the k angle residual parameter comprises:
predicting a value of the k angle parameter from among the first through n angle parameters;
comparing the predicted value of the k angle parameter with an original value of the k angle parameter; and
generating, according to the comparing, a difference value between the predicted value of the k angle parameter and the original value of the k angle parameter as the k angle residual parameter.

10. The signal processing method of claim 9, further comprising:
receiving, by a decoding apparatus, the spatial parameter comprising the k angle residual parameter and the angle parameters from among the first through n angle parameters except for the k angle parameter; and
restoring, by the decoding apparatus, the k angle parameter by using the received spatial parameter and the predetermined value.

11. The signal processing method of claim 10, wherein the restoring the k angle parameter comprises subtracting, from the predetermined value, a value of an angle parameter from among the first through n angle parameters except for the k angle parameter, and obtaining the k angle parameter as a value by compensating for the value of the k angle residual parameter to a value resulting from the subtracting.

12. A signal processing method performed by an encoding apparatus that down-mixes first through n channel signals to a mono-signal, the signal processing method comprising:
generating a spatial parameter by using a correlation between a reference channel signal and the mono-signal, the reference channel signal being from among the first through n channel signals; and
encoding and transmitting the generated spatial parameter.

13. The signal processing method of claim 12, further comprising:
receiving and decoding, by a decoding apparatus, the mono-signal and the encoded spatial parameter; and
restoring the first through n channel signals using the decoded mono-signal and the decoded spatial parameter

14. An encoding apparatus down-mixing first through n channel signals to a mono-signal, the encoding apparatus comprising:
a down-mixing unit which generates a spatial parameter between a reference channel signal and residual channel signals, the reference channel signal and the residual channel signals being from among the first through n channel signals; and
an encoder which encodes and transmits the generated spatial parameter.

15. The encoding apparatus of claim 14, wherein the down-mixing unit generates a summation signal by summing the residual channel signals, and generates the spatial parameter by using a correlation between the generated summation signal and the reference channel signal.

16. The encoding apparatus of claim 15, wherein the down-mixing unit generates n spatial parameters using each of the first through n channel signals as the reference channel signal.

17. The encoding apparatus of claim 16, wherein the encoder encodes a spatial parameter set comprising the generated first through n spatial parameters, encodes the mono-signal, generates a transport stream comprising the encoded spatial parameter set and the encoded mono-signal, and transmits the transport stream to a decoding apparatus.

18. The encoding apparatus of claim 14, wherein:
the spatial parameter comprises an angle parameter indicating a predetermined angle value that denotes a correlation between a signal magnitude of the reference channel signal and signal magnitudes of the residual channel signals; and
the down-mixing unit generates first through n angle parameters using each of the first through n channel signals as the reference channel signal.

19. The encoding apparatus of claim 18, wherein:
a total summation of the first through n angle parameters converges to a predetermined value; and
the down-mixing unit generates the spatial parameter comprising a k angle residual parameter used to calculate a k angle parameter and angle parameters from among the first through n angle parameters except for the k angle parameter.

20. The encoding apparatus of claim 19, wherein the down-mixing unit predicts a value of the k angle parameter from among the first through n angle parameters, compares the predicted value of the k angle parameter with an original value of the k angle parameter, and obtains a difference value between the predicted value of the k angle parameter and the original value of the k angle parameter as the k angle residual parameter.

21. A decoding apparatus comprising:
an inverse-multiplexing unit which receives a transport stream, and extracts an encoded spatial parameter from the received transport stream;
a spatial parameter decoding unit which decodes the encoded spatial parameter; and
an up-mixing unit which decodes a mono-signal generated by down-mixing and encoding first through n channel signals, and restores the first through n channel signals using the decoded mono-signal and the decoded spatial parameter,
wherein the spatial parameter comprises at least one of a first spatial parameter between a reference channel signal and residual channel signals and a second spatial parameter between the reference channel signal and the mono-signal, the reference channel signal and the residual channel signals being from among the first through n channel signals.

22. A decoding method comprising:
decoding an encoded spatial parameter;
decoding a mono-signal generated by down-mixing and encoding first through n channel signals; and
restoring the first through n channel signals using the decoded mono-signal and the decoded spatial parameter,
wherein the spatial parameter comprises at least one of a first spatial parameter between a reference channel signal and residual channel signals and a second spatial parameter between the reference channel signal and the mono-signal, the reference channel signal and the residual channel signals being from among the first through n channel signals.

23. The method of claim 22, wherein:
the decoding the encoded spatial parameter comprises decoding n spatial parameters; and
the restoring comprises restoring the first through n channel signals using the decoded n spatial parameters and the decoded mono-signal.

24. The method of claim 22, wherein the generated spatial parameter comprises an angle parameter indicating a predetermined angle value that denotes a correlation between a signal magnitude of the reference channel signal and signal magnitudes of the residual channel signals.

25. A computer readable recording medium having recorded thereon a program executable by a computer for performing the method of claim 1.

26. A computer readable recording medium having recorded thereon a program executable by a computer for performing the method of claim 12.

27. A computer readable recording medium having recorded thereon a program executable by a computer for performing the method of claim 22.
